(19) United States
(12) Patent Application Publication
(10) Pub. No.: US 2013/0176876 A1
(43) Pub. Date: Jul. 11, 2013

(54) RADIO COMMUNICATION TERMINAL DEVICE AND RADIO COMMUNICATION TERMINAL DEVICE CONTROL METHOD

(71) Applicant: FUJITSU MOBILE COMMUNICATIONS LIMITED, Kawasaki-shi (JP)

(72) Inventor: Atsushi WAKAYAMA, Hachioji (JP)

(73) Assignee: FUJITSU MOBILE COMMUNICATIONS LIMITED, Kawasaki-shi (JP)

(21) Appl. No.: 13/725,171

(22) Filed: Dec. 21, 2012

(30) Foreign Application Priority Data
Jan. 6, 2012 (JP) 2012-001269

(51) Int. Cl. H04W 72/04

(52) U.S. Cl. CPC H04W 72/048
USPC 370/252

(57) ABSTRACT

Radio control units concurrently perform two or more communications using two or more different communication schemes. Transmission power detection units detect the values of transmission power used for the communications that the radio control units perform using the respective communication schemes. A transmission power management unit obtains the sum of specific absorption rates associated with the respective communications, based on the values of transmission power thus detected by the transmission power detection units. Then, when the thus obtained sum of specific absorption rates exceeds a predetermined reference value, the transmission power management unit instructs protocol control units to perform the communications in a time-division manner in order for the respective communications using the two or more communication schemes to be non-concurrently performed.

### CROSS-REFERENCE TO RELATED APPLICATION

This application is based upon and claims the benefit of priority of the prior Japanese Patent Application No. 2012-001269, filed on Jan. 6, 2012, the entire contents of which are incorporated herein by reference.

### FIELD

The embodiments discussed herein are directed to a radio communication terminal device and a radio communication terminal device control method.

### BACKGROUND

Recently, various communication schemes have been proposed for radio communication. For example, schemes such as CDMA (Code Division Multiple Access) and LTE (Long Term Evolution) are known as communication schemes used in mobile phone devices. Hereinafter, these respective schemes are referred to as the CDMA scheme and the LTE scheme. Other communication schemes used in mobile phone devices include one specified by a standard (WiMAX (registered trademark): Worldwide Interoperability for Microwave Access) for immobile wireless communication, and one specified by a standard (WiFi (registered trademark): Wireless Fidelity) for wireless LANs. Hereinafter, these respective schemes are referred to as the WiMAX scheme and the WiFi scheme. It is thus likely that communications using two or more different communication schemes are concurrently performed in a radio communication terminal device capable of performing communications using various communication schemes.

Besides, it is known that, when a communication is performed through a radio communication terminal device, an electromagnetic wave is generated from the radio communication terminal device. An electromagnetic wave generated from a radio communication terminal device may affect human bodies. For this reason, SAR (Specific Absorption Rate), which represents the amount of energy absorbed by a human body, is used as a reference that represents the amount of influence that an electromagnetic wave outputted from a radio communication terminal device has on a human body in a certain period of time. The current situation is that a reference value indicating an electromagnetic wave level that is acceptable to a human body has been set. Specifically, for the reference value indicating an acceptable electromagnetic wave level, a standard in terms of SAR such that a value of SAR is not exceed 2 W/kg has been set.

The following conventional technologies have been proposed as countermeasures against electromagnetic waves generated from radio communication devices. For example, there is one conventional technology that reduces SAR with adjustment of the angle of an antenna (see, for example, Japanese Laid-open Patent Publication No. 2005-102205). Further, there is another conventional technology that uses a non-directional antenna in a standby status and uses a directional antenna during a voice call (see, for example, Japanese Laid-open Patent Publication No. 2005-217836). Further, there is still another conventional technology that, when an antenna and a head is close to each other, switches to an antenna having a directional characteristic that has a small influence (see, for example, Japanese Laid-open Patent Publication No. 2005-286741). Further, there is still another conventional technology that changes the value of transmission power in accordance with the distance of the device from a human body (see, for example, Japanese Laid-open Patent Publication No. 2005-286627). Further, there is still another conventional technology that aims at power saving in voice calls by switching between the values of transmission power that are for a voice call and for a data communication, respectively (see, for example, Japanese Laid-open Patent Publication No. 2001-292067).

However, when communications using two or more different communication schemes are concurrently performed, electromagnetic waves generated in aggregate from a radio communication terminal device may conflict with the SAR standard even in a case when an electromagnetic wave generated in the communication using each of the communication schemes falls within the SAR standard. For example, transmission power for near field radio communications through a WLAN, a Bluetooth (registered trademark) and the like is weak, and has a small influence on SAR. In contrast, transmission power for data communications using the WiMAX scheme, the LTE scheme and the like is high, and has a large influence on SAR. For this reason, in a case when a data communication is performed using the WiMAX scheme or the LTE scheme at the same time as a voice call using the CDMA scheme, it is difficult to set the sum of SAR values as a whole within the reference value under influences of electromagnetic waves associated with communications using the respective communication schemes.

In addition, the above described conventional technologies used as countermeasures for electromagnetic waves generated from radio communication devices are directed to reduction of SAR in communication using one communication scheme, and does not assume a case when communications using different communication schemes are concurrently performed. Therefore, when communications using two or more different communication schemes is concurrently performed, it is difficult for those technologies to set the sum of SAR values as a whole within the reference value.

### SUMMARY

According to an aspect of an embodiment, a radio communication terminal device includes: a radio communication unit that performs a plurality of communications by using a plurality of different communication schemes; a transmission power detection unit that detects transmission power used for communications that the radio communication unit performs by using the respective communication schemes; and a control unit that, based on the transmission power detected by the transmission power detection unit, obtains the sum of specific absorption rates associated with the respective communication schemes, and, when the thus obtained sum of the specific absorption rates exceeds a predetermined reference value, controls the radio communication unit to perform the communications in a time-division manner in order for the respective communications using the plurality of communication schemes to be non-concurrently performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a mobile phone device according to the first embodiment;

FIG. 2 is a diagram representing correlations between transmission power and SAR;

FIG. 3 is a diagram for illustrating changes in transmission power in a case when communications are being performed in a time-division manner in the first embodiment;

FIG. 4 is a sequence diagram of communications performed in a time-division manner by the mobile phone device according to the first embodiment;

FIG. 5 is a flowchart of communication control in the mobile phone device according to the first embodiment;

FIG. 6 is a diagram for illustrating changes in transmission power in a case when communications are being performed in a time-division manner in the second embodiment;

FIG. 7 is a diagram for illustrating changes in transmission power in a case when communications are being performed in a time-division manner in Variation 1;

FIG. 8 is a diagram for illustrating changes in transmission power in a case when communications are being performed in a time-division manner in Variation 2;

FIG. 9 is a flowchart depicting an example of processing in a case where methods of controlling time slots to be assigned to communications performed in a time-division manner are used in combination; and

FIG. 10 is a hardware configuration diagram of a mobile phone device.

### DESCRIPTION OF EMBODIMENTS

Preferred embodiments of the present invention will be explained with reference to accompanying drawings.

Note that the following embodiments are not intended to limit the radio communication terminal device and a radio communication terminal device control method that are disclosed by this application. Particularly, although the following description uses a mobile phone device as an example of the radio communication terminal device, the radio communication terminal device is not limited thereto, and may be any device that concurrently performs two or more communications by using two or more communication schemes.

### [a] First Embodiment

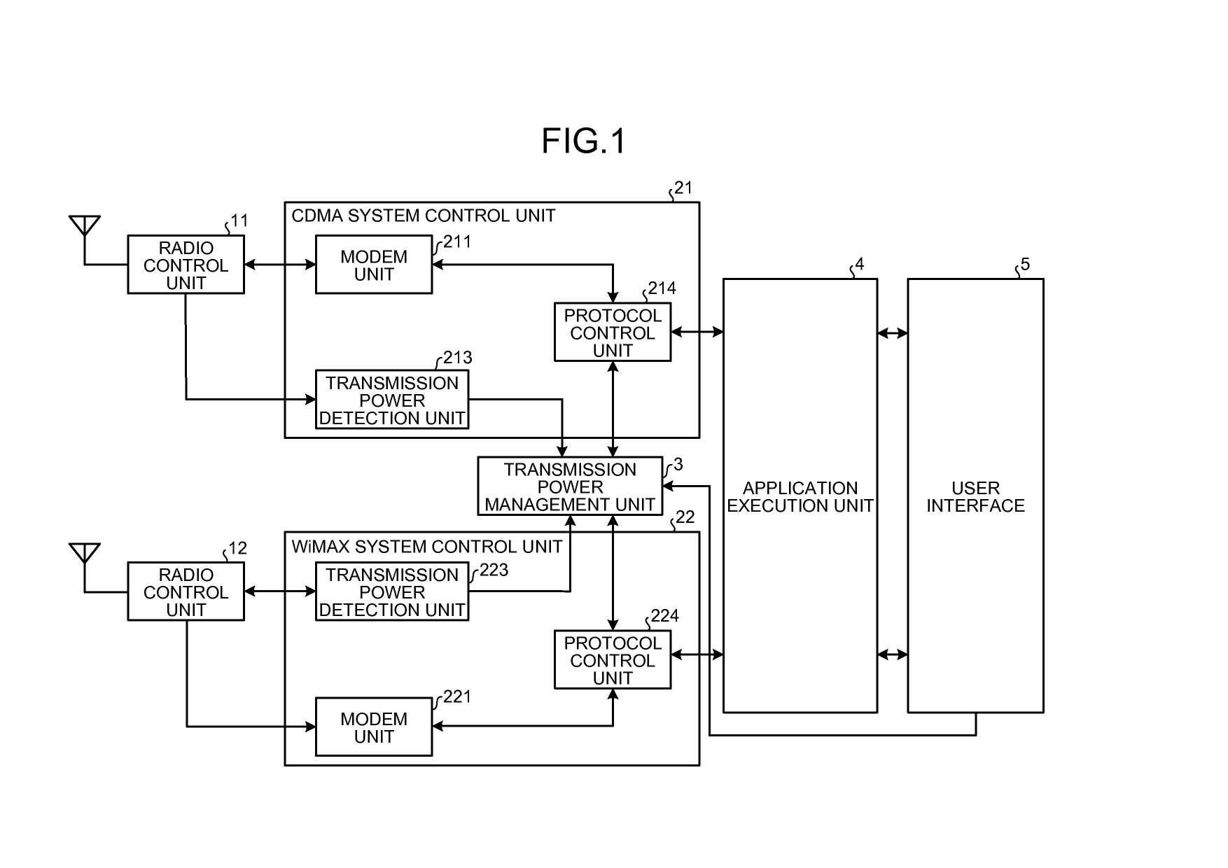

FIG. 1 is a block diagram of the mobile phone device according to a first embodiment. As depicted in FIG. 1, the mobile phone device according to this embodiment has radio control units 11 and 12, a CDMA system control unit 21, a WiMAX system control unit 22, a transmission power management unit 3, an application execution unit 4 and a user interface 5.

The radio control unit 11 receives from a modem unit 211 an input of data, which is a baseband signal. Then, the radio control unit 11 generates radio signal data by performing frequency conversion on the received data. Then, the radio control unit 11 transmits the radio signal data to an external apparatus such as a base station through communication compliant with the CDMA scheme. Hereinafter, a radio signal compliant with the CDMA scheme is referred to as a “CDMA signal”.

Additionally, the radio control unit 11 receives a CDMA signal through an antenna from a base station. The radio control unit 11 generates a baseband signal by performing frequency conversion on the received CDMA signal into the baseband bandwidth. The radio control unit 11 outputs to the modem unit 211 the CDMA signal that have been converted into a baseband signal.

The radio control unit 12 is approximately the same as the radio control unit 11, and the explanation thereof is omitted. One exception is that the radio control unit 12 transmits data by using the WiMAX scheme.

The CDMA system control unit 21 includes the modem unit 211, a transmission power detection unit 213 and a protocol control unit 214.

The modem unit 211 receives, from the protocol control unit 214, data to be transmitted and a data transmission instruction together. The modem unit 211 performs demodulation and decoding on the CDMA signal that has been converted into a baseband signal. Then, the modem unit 211 outputs to the protocol control unit 214 the CDMA signal on which demodulation and decoding have been performed.

Further, the modem unit 211 receives, from the protocol control unit 214, input of a baseband signal for data to be transmitted to an external apparatus such as a base station. Then, the modem unit 211 performs encoding and modulation on the received baseband signal. Thereafter, the modem unit 211 outputs, to the radio control unit 11, the baseband signal on which encoding and modulation have been performed.

The transmission power detection unit 213 detects a transmission power used by the radio control unit 11 for data transmission. Then, the transmission power detection unit 213 outputs the detected transmission power to the transmission power management unit 3.

The protocol control unit 214 processes a call request, a handover and the like in communication using the CDMA scheme. Additionally, the protocol control unit 214 receives input of data such as voice data from the application execution unit 4. Then, the protocol control unit 214 outputs the received data to the modem unit 211. Further, the protocol control unit 214 receives a transmission power control instruction from the transmission power management unit 3 when the sum of SAR values exceeds the reference value. In this embodiment, the protocol control unit 214 receives, from the transmission power management unit 3, instructions for stopping and restarting communication, namely, instructions on communication performed in a time-division manner. Then, in accordance with the instructions from the transmission power management unit 3, the protocol control unit 214 outputs, to the modem unit 211, an instruction for executing communication using the CDMA scheme. Specifically, upon receipt of an instruction for stopping communication, the protocol control unit 214 keeps, until the receipt of the instruction for starting communication, the instruction for executing communication from being transmitted toward the modem unit 211. Thereafter, upon receipt of an instruction for starting communication, the protocol control unit 214 outputs the instruction for executing communication to the modem unit 211.

Additionally, while the instruction for stopping the communication is effective, the protocol control unit 214 detects an RSSI between itself and an external apparatus that the protocol control unit 214 communicates with. Then, the protocol control unit 214 outputs the detected RSSI to the transmission power management unit 3.

The WiMAX system control unit 22 includes a modem unit 221, a transmission power detection unit 223 and a protocol control unit 224. The respective units of the WiMAX system control unit 22 perform the same operations as the respective units of the CDMA system control unit 21 by using WiMAX as a communication scheme. For this reason, explanation of the operations of the WiMAX system control unit 22 is omitted.

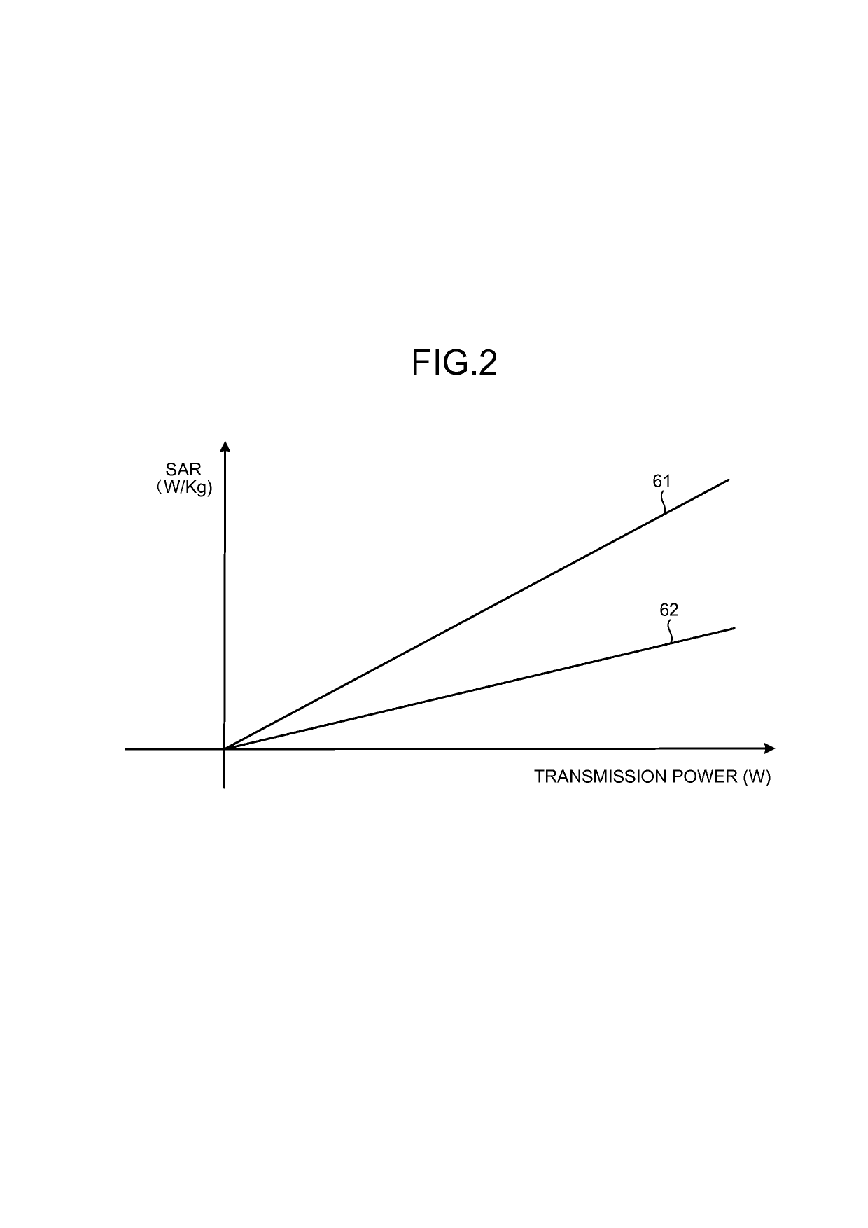

For example, the transmission power management unit 3 stores the SAR reference value and information on correlations between transmission power and SAR. The SAR reference value is an upper limit value of the SAR value associated with an electromagnetic wave generated from a mobile phone device. In this embodiment, the SAR reference value is set to, for example, 2.0 W/kg, which is a legal standard. The information on correlations between transmission power and SAR is, for example, graphs representing correlations as depicted in FIG. 2. FIG. 2 is a diagram representing correlations between transmission power and SAR. In FIG. 2, the vertical axis represents the SAR value, and the horizontal axis represents the value of transmission power. A graph 61 in FIG. 2 represents a correlation between transmission power and SAR that are associated with the CDMA scheme. On the other hand, a graph 62 represents a correlation between transmission power and SAR that are associated with the WiMAX scheme. As depicted in FIG. 2, in each of the graphs 61 and 62, the SAR value increases in proportion to the value of transmission power. Additionally, the SAR value associated with the CDMA scheme is larger than that associated with the WiMAX scheme. Here, although a graph that expresses a correlation is used as the information on a correlation between transmission power and SAR in this embodiment, any other form, such as a table or a relational expression, that makes it possible to obtain an SAR value from the value of transmission power may be adopted alternatively.

Additionally, the transmission power management unit 3 includes a timer. Further, the transmission power management unit 3 stores: an SAR detection interval that is applicable to a case when communications are not being performed in a time-division manner; and an SAR detection interval that is applicable to a case when communications are being performed in a time-division manner. Then, the transmission power management unit 3 measures time by using its own timer, and receives the value of transmission power used for a CDMA-scheme communication from the transmission power detection unit 213 at the SAR detection intervals that are applicable to a case when communications are not being performed in a time-division manner. Further, the transmission power management unit 3 receives the value of transmission power for a WiMAX-scheme communication from the transmission power detection unit 223 at the same time as receiving that for the CDMA-scheme communication.

Then, from the information on correlations between transmission power and SAR, the transmission power management unit 3 acquires an SAR value that corresponds to the value of transmission power thus received from the transmission power detection unit 213. Additionally, from the information on correlations between transmission power and SAR, the transmission power management unit 3 acquires an SAR value that corresponds to the value of transmission power thus received from the transmission power detection unit 223. Further, the transmission power management unit 3 calculates the sum of the acquired SAR values. Then, the transmission power management unit 3 determines whether the thus calculated sum of the SAR values exceeds the SAR reference value. When the sum of the SAR values exceeds the SAR reference value, the transmission power management unit 3 determines that the CDMA-scheme communication and the WiMAX-scheme communication is performed in a time-division manner. In this embodiment, the transmission power management unit 3 determines that each of the CDMA-scheme communication and the WiMAX-scheme communication is equally divided by time. That is, in this embodiment, the transmission power management unit 3 determines that each of the CDMA-scheme communication and the WiMAX-scheme communication is repeated for a predetermined period. Thereafter, the transmission power management unit 3 determines timing of starting the CDMA-scheme communication and timing of starting the WiMAX-scheme communication. Then, the transmission power management unit 3 instructs the protocol control unit 214 to restart the communication in accordance with the timing of starting the CDMA-scheme communication, and instructs the protocol control unit 224 to stop the communication. Additionally, the transmission power management unit 3 instructs the protocol control unit 224 to restart the communication in accordance with the timing of starting the WiMAX-scheme communication, and instructs the protocol control unit 214 to stop the communication. On the other hand, when the sum of the SAR values is less than the SAR reference value, the transmission power management unit 3 is left to continue monitoring the SAR.

Further, after having started performing the communications in a time-division manner, the transmission power management unit 3 measures time by using its own timer, and calculates the sum of the SAR values at the SAR detection intervals that are applicable in a case when communications are performed in a time-division manner. However, when communication is being performed in a time-division manner, only one communication that uses any one of the CDMA and WiMAX schemes is performed, whereas any communication using the other one of these communication schemes is actually being stopped. For this reason, the transmission power management unit 3 acquires a value of RSSI (Received Signal Strength Indication) from the protocol control unit 214 or 224 with which a communication has been stopped. Then, from the received RSSI, the transmission power management unit 3 acquires a predicted value of the transmission power, namely, a value that represents how much transmission power is used for communication that is supposed to be performed at given timing. Here, in order to obtain the transmission power from the RSSI, the transmission power management unit 3 may store a table representing correspondences between RSSI and transmission power, and acquire, from the table, the value of transmission power that corresponds to the received RSSI, or alternatively, may calculate the value of transmission power by using a formula provided for obtaining the transmission power from the RSSI. Then, from the correlation information on the transmission power and the SAR, the transmission power management unit 3 acquires an SAR value that corresponds to the predicted value of the transmission power for the stopped communication. Additionally, from any one of the transmission power detection units 213 and 223 that is currently performing communication, the transmission power management unit 3 acquires the transmission power with respect to the communication scheme for the currently performed communication. Then, from the information on correlations between transmission power and SAR, the transmission power management unit 3 acquires an SAR value that corresponds to the transmission power with respect to the communication scheme for the currently performed communication. Thereafter, the transmission power management unit 3 calculates the sum (hereinafter, sometimes referred to as “the predicted value of the sum of SAR values”) of the SAR values that corresponds to the predicted value of the transmission power with respect to the communication scheme for the stopped communication and corresponds to the transmission power with respect to the communication scheme for the currently performed communication, respectively. Then, the transmission power management unit 3 determines whether the predicted value of the sum of SAR values is within the SAR reference value. When the predicted value of the sum of SAR values is within the SAR reference value, the transmission power management unit 3 cancels the time-division manner applied to the communications, and instructs the protocol control unit 214 and 224 to concurrently perform the CDMA-scheme communication and the WiMAX-scheme communication, respectively. On the other hand, when the predicted value of the sum of SAR values is larger than the SAR reference value, the transmission power management unit 3 continues performing the communications in a time-division manner.

Upon receipt of an application start instruction from the user interface 5, the application execution unit 4 performs a corresponding one of various applications. Additionally, the application execution unit 4 receives input of data to be used in the application from the user interface 5.

Additionally, when the currently executed application performs communication with external equipment, the application execution unit 4 instructs the protocol control unit 214 that performs communication using a communication scheme used by the application to execute the communication. For example, in a case where the application is one that transmits and receives data by using WiMAX, the application execution unit 4 instructs the protocol control unit 224 to transmit data when the application is to transmit data.

Further, the application execution unit 4 outputs to the user interface 5 output data obtained through execution of an application.

The user interface 5 includes a liquid crystal screen, a keypad, a microphone, a speaker and the like. A user (hereinafter, referred to as “operator”) of the mobile phone device performs data acquisition, data input and the like by using the user interface 5. For example, the operator performs information input by using the keypad with reference to the liquid crystal screen, and makes a voice call by using the microphone and the speaker. Data inputted from the user interface 5 is outputted to the application execution unit 4. Additionally, data outputted by the application execution unit 4 is provided to the operator by the user interface 5.

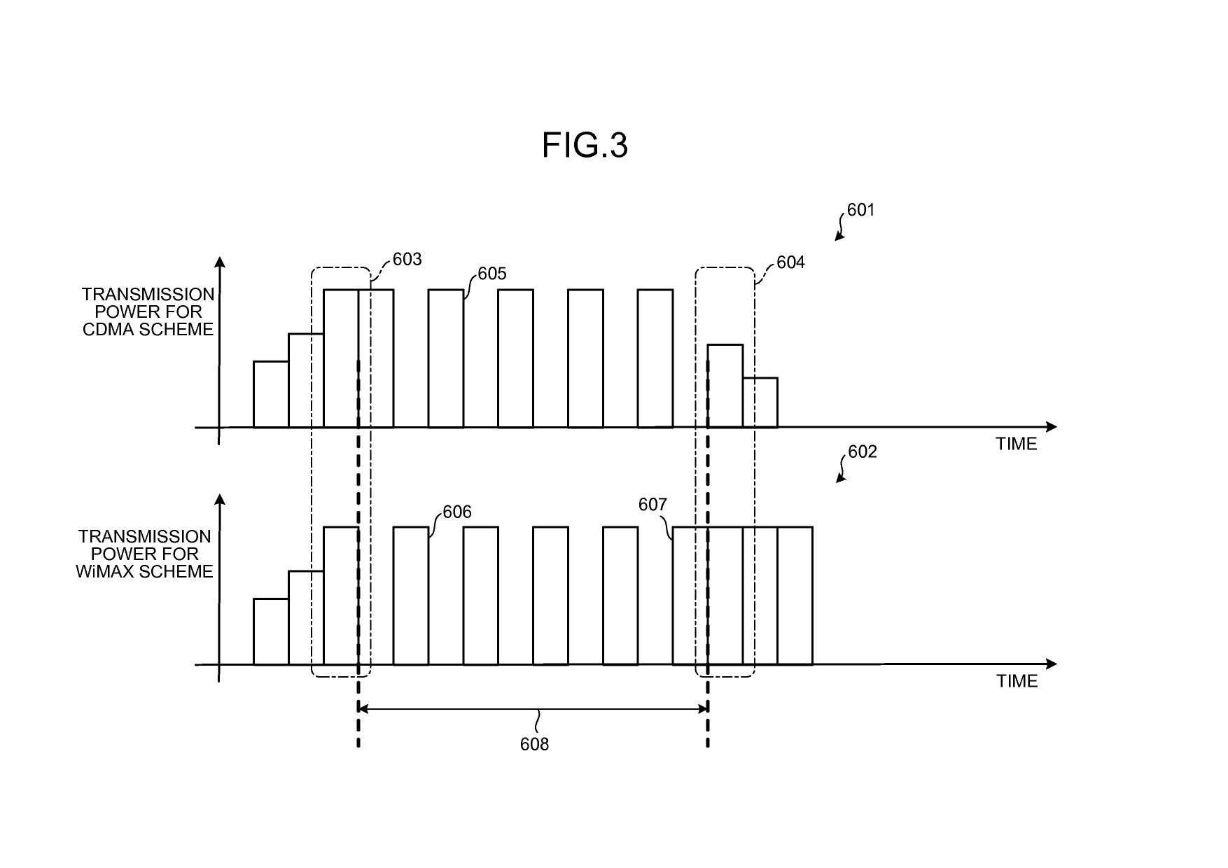

Next, changes in transmission power during when communications are performed in a time-division manner in the mobile phone device according to this embodiment are described with reference to FIG. 3. FIG. 3 is a diagram for illustrating changes in transmission power in a case when communications are performed in a time-division manner in the first embodiment. A graph 601 of FIG. 3 represents changes over time in transmission power for the CDMA scheme. On the other hand, a graph 602 of FIG. 3 represents changes over time in transmission power for the WiMAX scheme. In each of the graph 601 and the graph 602, the vertical axis represents transmission power, and the horizontal axis represents time.

As indicated by the graphs 601 and 602, the mobile phone device according to this embodiment is concurrently performing the CDMA-scheme communication and the WiMAX-scheme communication at the start. Then, at a time point 603, the transmission power management unit 3 determines the sum of SAR values to have exceeded the SAR reference value. In that case, the transmission power management unit 3 starts performing the communications in a time-division manner where the CDMA-scheme communication and the WiMAX-scheme communication are alternately repeated with each being performed for a predetermined time period. The WiMAX-scheme communication and the CDMA-scheme communication are not concurrently performed while being performed in a time-division manner. That is, as in the cases of transmission power 605 and transmission power 606, the presence of transmission power for WiMAX-scheme communication and the presence of transmission power for CDMA-scheme communication are not concurrently performed. Besides, in the mobile phone according to this embodiment, it is ensured that an SAR value derived only from a communication using a single communication scheme is less than or equal to the SAR reference value. Therefore, it is ensured that the sum of an SAR value from the CDMA-scheme communication and an SAR value from the WiMAX-scheme communication is less than or equal to the SAR reference value in communications performed in a time-division manner.

Further, while communications are performed in a time-division manner, the transmission power management unit 3 calculates the sum of SAR values, one of which corresponds to a predicted value of transmission power for the communication scheme with which communication is being stopped, and the other one of which corresponds to transmission power for the other communication scheme with which communication is being performed, namely, a predicted value of the sum of SAR values. For example, at a time point corresponding to the transmission power 605, the transmission power management unit 3 calculates the sum of an SAR value corresponding to the transmission power 605 and an SAR value corresponding to a predicted value of transmission power in the WiMAX-scheme communication at this time point. Then, when the predicted value of the sum of SAR values has fallen below the SAR reference value, the transmission power management unit 3 cancels the time-division manner applied to the communications. FIG. 3 assumes that the predicted value of the sum of SAR values falls below the SAR reference value when transmission power 607 has emerged for the WiMAX-scheme. In this case, the transmission power management unit 3 instructs the protocol control units 214 and 224 to cancel, at a time point 604, the time-division manner applied to the communications and then concurrently perform the CDMA-scheme communication and the WiMAX-scheme communication. By the time point 604, the transmission power for CDMA-scheme communication has gone down already, so that the sum of SAR values has been less than or equal to the SAR reference value. In this case, a time period 608 turns out to be a time period when the communications have been performed in a time-division manner.

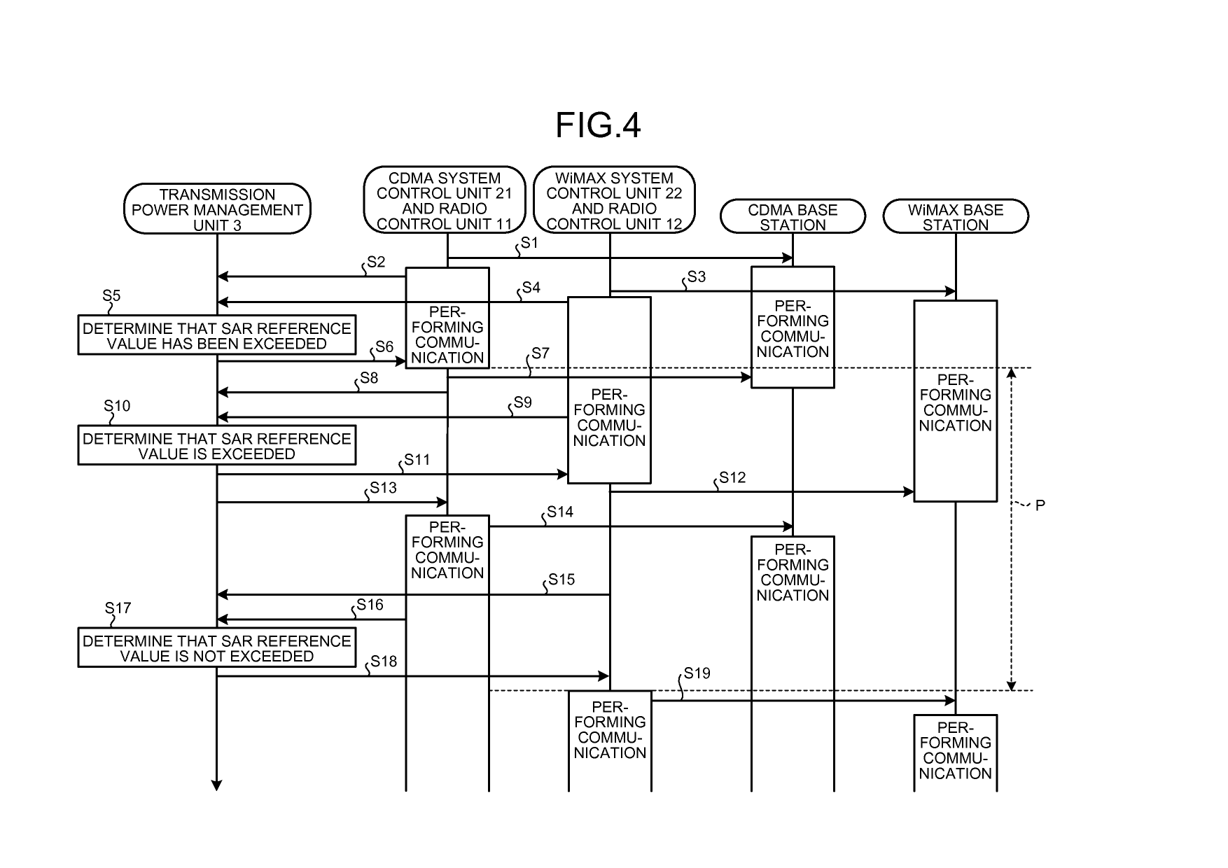

Next, a data flow in a case when communications are performed in a time-division manner in the mobile phone device according to this embodiment is described with reference to FIG. 4. FIG. 4 is a sequence diagram of communications performed in a time-division manner by the mobile phone device according to the first embodiment.

The respective vertical axes represent processing in the above described individual units and external equipment. An arrow that heads outward from one of the axes to another indicates transmission of data, and any arrow that heads toward the one from another indicates reception of data.

The CDMA system control unit 21 notifies, through the radio control unit 11, a CDMA base station that communication is to be started (step S1). This causes communication using the CDMA scheme to be started between the mobile phone device and the CDMA base station. While performing communication, the CDMA system control unit 21 notifies the transmission power management unit 3 of transmission power (step S2).

Then, the WiMAX system control unit 22 notifies, through the radio control unit 12, a WiMAX base station that communication is to be started (step S3). This causes communication using the WiMAX scheme to be started between the mobile phone device and the WiMAX base station. When the communication is started, the mobile phone device concurrently performs communication using the CDMA scheme and communication using the WiMAX scheme. While performing communication, the WiMAX system control unit 22 notifies the transmission power management unit 3 of transmission power (step S4).

Thereafter, the transmission power management unit 3 determines the sum of SAR values each obtained from the transmission power to have exceeded the SAR reference value (step S5). Then, the transmission power management unit 3 instructs the CDMA system control unit 21 to stop the communication using the CDMA scheme (step S6). In response to this instruction, the CDMA system control unit 21 stops the communication, and notifies the CDMA base station that the communication is to be stopped (step S7). This causes the CDMA base station as well to stop the communication. Application of a time-division manner to the communications is started at this time point. In this embodiment, description is given of a case where, after a WiMAX-scheme communication is performed as a communication that is performed firstly among the communications performed in a time-division manner, a CDMA-scheme communication and the WiMAX-scheme communication are repeated alternately sequentially.

Then, when communications are being performed in a time-division manner, the CDMA system control unit 21 notifies the transmission power management unit 3 of the RSSI in a time period during which the communication has been stopped (step S8). From the RSSI, the transmission power management unit 3 obtains a predicted value of transmission power for the CDMA-scheme communication. Additionally, the WiMAX system control unit 22 notifies the transmission power management unit 3 of an actual value of transmission power (step S9). Then, the transmission power management unit 3 obtains an SAR value in the CDMA-scheme communication from the predicted value of transmission power, and obtains an SAR value in the WiMAX-scheme communication from the transmission power for the WiMAX-scheme communication. Then, the transmission power management unit 3 obtains a predicted value of the sum of SAR values and determines that the thus obtained predicted value of the sum of SAR values exceeds the SAR reference value (step S10).

Then, the transmission power management unit 3 instructs the WiMAX system control unit 22 to stop the WiMAX-scheme communication (step S11). In response to this instruction, the WiMAX system control unit 22 stops the communication, and notifies the WiMAX base station that the communication is to be stopped (step S12). This causes the CDMA base station as well to stop the communication. Further, the transmission power management unit 3 notifies the CDMA system control unit 21 that the CDMA-scheme communication is to be restarted (step S13). In response to this notification, the CDMA system control unit 21 notifies the CDMA base station that the CDMA-scheme communication is to be restarted (step S14). This causes communication between the mobile phone device and the CDMA base station equipment to be restarted.

Then, when the communications are being performed in a time-division manner, the WiMAX system control unit 22 notifies the transmission power management unit 3 of the RSSI in a time period during which the communication therewith has been stopped (step S15). The transmission power management unit 3 obtains a predicted value of the transmission power in the WiMAX-scheme communication from the RSSI. Additionally, the CDMA system control unit 21 notifies the transmission power management unit 3 of an actual value of transmission power (step S16). Then, the transmission power management unit 3 obtains an SAR value for the WiMAX-scheme communication from the predicted value of transmission power, and obtains an SAR value for the CDMA-scheme communication from the transmission power for the CDMA-scheme communication. Then, the transmission power management unit 3 obtains a predicted value of the sum of SAR values, and determines that the thus obtained predicted value of the sum of SAR values is less than or equal to the SAR reference value (step S17).

The transmission power management unit 3 notifies the WiMAX system control unit 22 that the WiMAX-scheme communication is to be restarted (step S18). In response to this, the WiMAX system control unit 22 notifies the WiMAX base station that the communication is to be restarted (step S19). This causes communication between the mobile phone device and the WiMAX base station equipment to be restarted. From this time on, the mobile phone device concurrently performs the CDMA-scheme communication and the WiMAX-scheme communication again.

Here, in the processing illustrated in FIG. 4, a time period P is a time period for which communications are performed in a time-division manner. As communications performed in time periods other than the time period P, the CDMA-scheme communication and the WiMAX-scheme communication are concurrently performed.

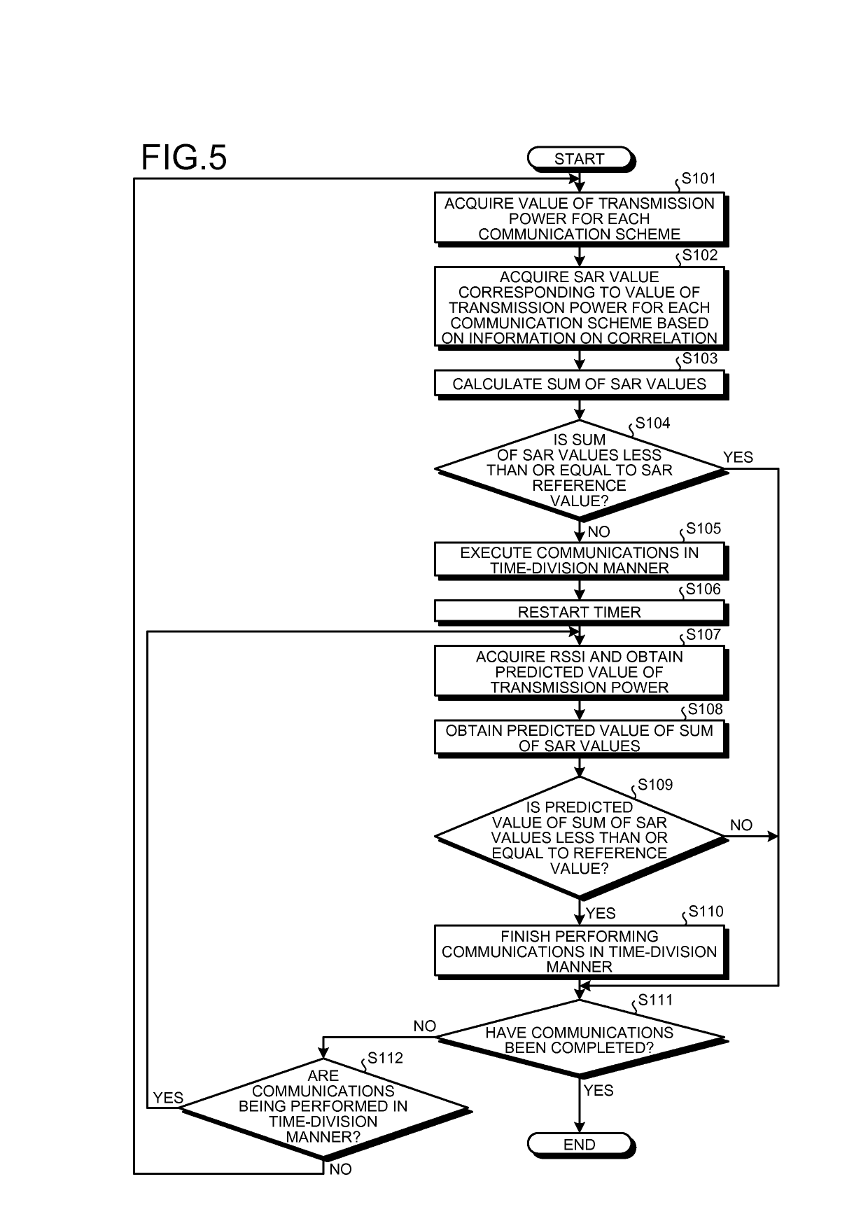

Then, a flow of communication control in the mobile phone device according to this embodiment is described with reference to FIG. 5. FIG. 5 is a flowchart of the communication control in the mobile phone device according to the first embodiment. The flow in FIG. 5 starts from a state where a CDMA-scheme communication and a WiMAX-scheme communication are being concurrently performed.

The transmission power management unit 3 acquires the values of transmission power for the respective communication schemes from the transmission power detection units 213 and 223 at the SAR detection intervals that are applicable to a case when communications are not being performed in a time-division manner (step S101). Then, the transmission power management unit 3 acquires SAR values corresponding to the respective communication schemes, from the information on correlations between transmission power and SAR values, in individual manners corresponding to the respective communication schemes (step S102).

Then, the transmission power management unit 3 calculates the sum of the SAR values corresponding to the respective communication schemes (step S103).

The transmission power management unit 3 determines whether the sum of the SAR values is less than or equal to the SAR reference value (step S104). When the sum is less than or equal to the SAR reference value (step S104: Yes), the processing proceeds to step S111.

On the other hand, when the sum exceeds the SAR reference value (step S104: No), the transmission power management unit 3 applies a time-division manner to the communications by notifying the protocol control units 214 and 224 that the respective communications are to be stopped and restarted (step S105).

Additionally, the transmission power management unit 3 restarts the timer to measure the SAR detection interval that is applicable to a case when communications are being performed in a time-division manner (step S106).

From the protocol control unit 214 or 224 with which communication has been stopped, the transmission power management unit 3 acquires the RSSI at the SAR detection intervals that are applicable to a case when communications are being performed in a time-division manner. Then, the transmission power management unit 3 obtains a predicted value of transmission power from the acquired RSSI (step S107).

Further, the transmission power management unit 3 acquires the value of transmission power for the communication scheme that is performing communication. Then, the transmission power management unit 3 calculates an SAR value that corresponds to the transmission power for the communication scheme that is performing communication, and an SAR value that corresponds to the predicted value of the transmission power. Then, the transmission power management unit 3 obtains a predicted value of the sum of SAR values (step S108).

Then, the transmission power management unit 3 determines whether the thus obtained predicted value of the sum of SAR values is less than or equal to the SAR reference value (step S109). When the predicted value of the sum of the SAR values exceeds the SAR reference value (step S109: No), the processing proceeds to step S111.

On the other hand, when the predicted value of the sum of the SAR values is less than or equal to the SAR reference value (step S109: Yes), the transmission power management unit 3 notifies the protocol control unit 214 or 224 with which a communication has been stopped that the communication is restarted, and thereby finishes performing the communications in a time-division manner (step S110).

Then, the transmission power management unit 3 determines whether the communications have been completed (step S111). When the communications have not been completed yet (step S111: No), the transmission power management unit 3 determines whether the communications are being performed in a time-division manner (step S112). When the communications are not being performed in a time-division manner (step S112: No), the transmission power management unit 3 returns to step S101. On the other hand, when the communications are being performed in a time-division manner (step S112: Yes), the transmission power management unit 3 returns to step S107.

On the other hand, when the communications have been completed (step S111: Yes), the transmission power management unit 3 terminates the communication control using SAR values.

As described above, when SAR has exceeded a predetermined reference value, the radio communication terminal device according to this embodiment performs, in a time-division manner, communications using the respective communication schemes. This makes it possible to reduce the influence on a human body by making it possible to keep, under a legal standard, the sum of SAR values derived from communications using the respective communication schemes. Additionally, when being performed in a time-division manner, communications using the respective communication schemes are performed using transmission power according to the states of the respective communications. Therefore, it is made possible to reduce the chance of retransmission as compared to a case where transmission power is reduced.

### [b] Second Embodiment

Next, a second embodiment is described. A radio communication terminal device according to this embodiment is different from that of the first embodiment in that the length of a time slot assigned to each of communication schemes is variable in accordance with the state of a communication using the communication scheme when communications are being performed in a time-division manner. FIG. 1 represents the functional blocks of a mobile phone device according to this embodiment as well. In the mobile phone device according to this embodiment, a unit that has the same reference sign as any one of the units in the first embodiment is assumed to have the same function as the unit unless otherwise stated. In the following description, explanation of functions described in connection with the first embodiment is omitted.

The transmission power management unit 3 acquires transmission power for the respective communication schemes from the transmission power detection units 213 and 223. Then, after having obtained SAR values from the thus acquired transmission power, the transmission power management unit 3 calculates the sum of the SAR value. The transmission power management unit 3 determines whether the sum of the SAR values is less than or equal to the SAR reference value.

When the sum of the SAR values exceeds the SAR reference value, the transmission power management unit 3 acquires, from the protocol control units 214 and 224, information on whether a communication performed using each of the communication schemes is a voice call. Here, the protocol control units 214 and 224 acquire, from the application execution unit 4, information on which one of applications is currently being executed. This makes it possible for these units to grasp whether the currently performed communication is a voice call.

Then, when there is any communication scheme through which a voice call is being made, the transmission power management unit 3 determines when to perform communications using the respective communication schemes, so that a longer time slot may be assigned to the communication scheme through which a voice call is made than to the other communication scheme among the communications performed in a time-division manner. For example, when the a communication other than a voice call is being performed using the WiMAX scheme while a voice call is being performed through the CDMA scheme, the transmission power management unit 3 sets a time slot assigned to the CDMA-scheme communication longer than a time slot assigned to the WiMAX-scheme communication. Hereinafter, description is given of a case when a voice call is being performed using the CDMA scheme.

Then, so that the communication using the respective communication schemes is performed at the determined timing, the transmission power management unit 3 notifies the protocol control units 214 and 224 of instructions thereto to stop and restart the communication. This causes the radio control units 11 and 12, the CDMA system control unit 21 and the WiMAX system control unit 22 to perform communications a time-division manner where a longer time slot is assigned to a voice call.

Further, from the protocol control unit 214, the transmission power management unit 3 acquires information on data transmission and reception in the voice call sometime during the communication time period assigned to the communication, using the CDMA scheme, performed in a time-division manner. Then, the transmission power management unit 3 determines whether the voice call has been interrupted due to the state of data transmission and reception in the voice call. For example, when data transmission and reception in the voice call has not been performed for a certain period of time, the transmission power management unit 3 determines that the voice call has been interrupted. Then, when the voice call has been interrupted, the transmission power management unit 3 notifies the protocol control unit 224 that the communication using the WiMAX scheme is restarted. Thereafter, the transmission power management unit 3 continues monitoring information, on data transmission and reception in the voice call, acquired from the protocol control unit 214, and, after data transmission and reception in the voice call is restarted, instructs the protocol control unit 224 to stop the communication using the WiMAX scheme. This enables the WiMAX system control unit 22 and the radio control unit 12 to perform the communication using the WiMAX scheme while the voice call is being interrupted.

Thereafter, at predetermined SAR detection intervals that are applicable to a case when communications are performed in a time-division manner where a longer time slot is assigned to a voice call, the transmission power management unit 3 determines whether a predicted value of the sum of SAR values is less than or equal to the SAR reference value. Then, when the predicted value of the sum of SAR values is less than or equal to the SAR reference value, the transmission power management unit 3 cancels the time-division manner applied to the communications.

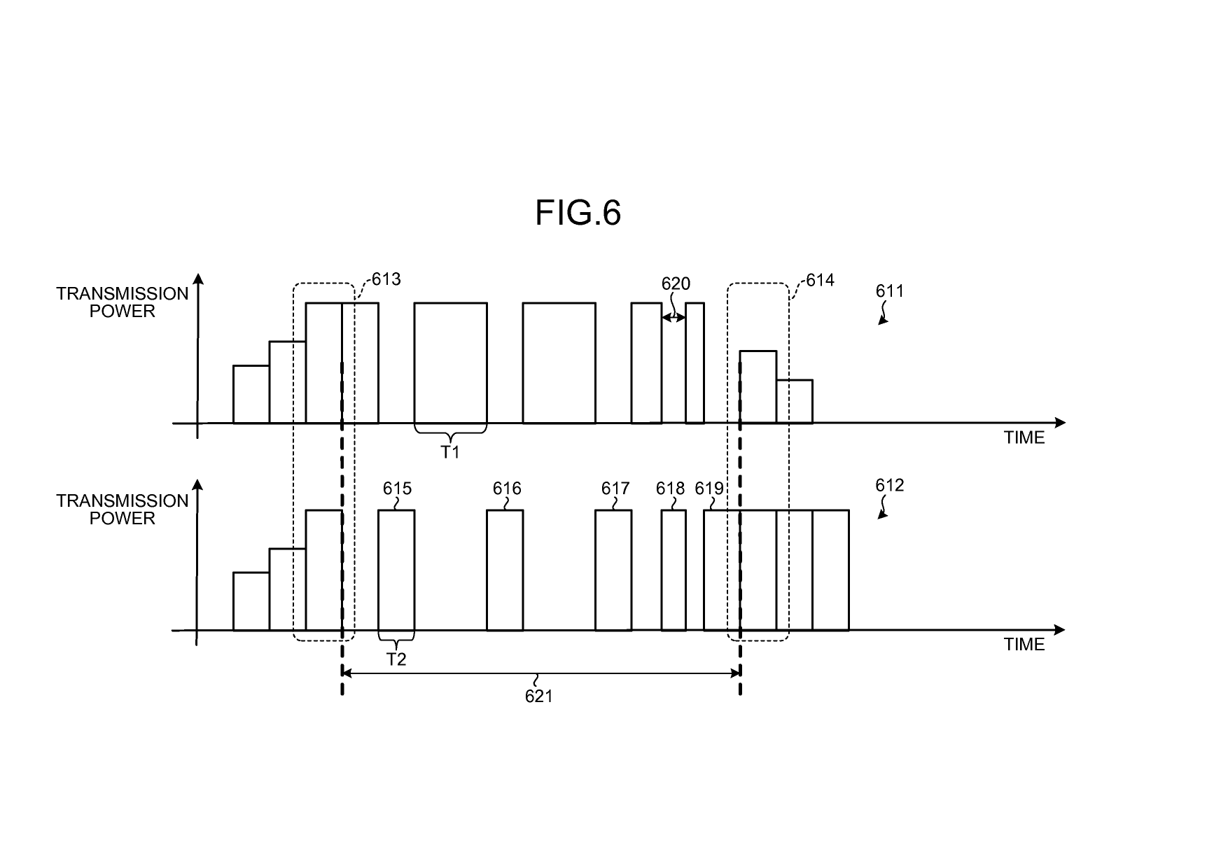

Then, changes in transmission power in a case where communications are being performed in a time-division manner in the mobile phone device according to this embodiment are described with reference to FIG. 6. FIG. 6 is a diagram for explaining changes in transmission power in a case when communications are performed in a time-division manner in the second embodiment. A graph 611 of FIG. 6 represents changes over time in transmission power for the CDMA scheme. On the other hand, a graph 612 of FIG. 6 represents changes over time in transmission power for the WiMAX scheme. In each of the graphs 611 and 612, the vertical axis represents transmission power, and the horizontal axis represents time.

As depicted in the graphs 611 and 612, the mobile phone device according to this embodiment concurrently performs CDMA-scheme communication and WiMAX-scheme communication at the start. Then, at a time point 613, the transmission power management unit 3 determines the sum of SAR values to be larger than the SAR reference value. Further, the transmission power management unit 3 determines whether any one of the communication schemes is performing communication that is a voice call. Here, it is assumed that the CDMA scheme is used for performing a voice call. In that case, the transmission power management unit 3 starts performing the communications in a time-division manner where communication time periods assigned to the respective communication schemes so that a longer time period may be assigned to the CDMA-scheme communication than to the WiMAX-scheme communication are alternatively repeated. For example, the transmission power management unit 3 assigns a time period of T1 to the CDMA scheme, and assigns a time period of T2 that satisfies T1>T2 to the WiMAX scheme. Then, the transmission power management unit 3 repeats the communications in a time-division manner where, after the CDMA-scheme communication is performed for a time period of T1, the WiMAX-scheme communication is performed for a time period of T2. In this case, as in the case of transmission power 615 to 617, when there is no interruption in the voice call, transmission power emerges for time periods of T2 in the WiMAX-scheme communication at intervals that are equivalent to time periods of T1. Then, when the voice call has been interrupted, the transmission power management unit 3 causes the WiMAX-scheme communication to be performed during the interruption of the voice call. That is, when there is a time period such as a time period 620 when the voice call is being interrupted, transmission power 618 emerges for the WiMAX-scheme communication throughout the time period. Then, when a time period of T1 assigned to the CDMA scheme has elapsed after the voice call has been restarted, the transmission power management unit 3 causes the WiMAX-scheme communication to be restarted. That is, transmission power 619 emerges for the WiMAX-scheme communication. Here, as depicted in FIG. 6, the WiMAX-scheme communication and the CDMA-scheme communication are not concurrently performed while being performed in a time-division manner. Additionally, during the time period 620, the voice call has been interrupted and does not use transmission power. Therefore, performing a WiMAX-scheme communication during the time period 620 does not cause superimposition of electromagnetic waves derived from transmission power for the respective communication schemes. Therefore, the sum of an SAR value associated with the CDMA-scheme communication and an SAR value associated with the WiMAX-scheme communication remains less than or equal to the SAR reference value.

Further, while performing the communications in a time-division manner, the transmission power management unit 3 calculates the sum of an SAR value corresponding to a predicted value of transmission power for the communication scheme with which communication is being stopped, and an SAR value corresponding to transmission power for the communication scheme with which communication is being performed, namely, a predicted value of the sum of SAR values. Then, when the predicted value of the sum of the SAR values exceeds the SAR reference value, the transmission power management unit 3 cancels the time-division manner applied to the communications. Here, it is assumed that the predicted value of the sum of SAR values is less than the SAR reference value when the transmission power 619 for the WiMAX scheme has emerged. In this case, the transmission power management unit 3 instructs the protocol control units 214 and 224 to cancel, at a time point 614, the time-division manner applied to the communications and then concurrently perform the CDMA-scheme communication and the WiMAX-scheme communication. By the time point 614, transmission power for the CDMA-scheme communication has already gone down, and hence, the sum of the SAR values has been less than or equal to the SAR reference value. In this case, a time period 621 turns out to be a time period for which the communications have been performed in a time-division manner.

The communication control thus performed by the transmission power management unit 3 enables communications to be performed in a time-division manner where a longer time slot is assigned to a voice call. The communication control thereby makes it possible to avoid superimposition of transmission power for communications performed with different communication schemes. Additionally, a time slot assigned to a voice call is set longer, and a time slot assigned to the other type of communication is set shorter. This makes it possible to involve less frequent breaks in the voice call, and provide a smooth voice call. Further, when a voice call has been interrupted and is not using transmission power, the communication control makes it possible to perform a communication using the other communication scheme, thereby making it possible to complete a communication other than a voice call in the shortest possible time while avoiding superimposition of transmission power for communications using different communication schemes.

Variation 1

Next, Variation 1 of the second embodiment is described. This variation is characterized in that time slots assigned for communications performed in a time-division manner may be changed based on whether the communication demands immediacy. Here, communication that demands immediacy refers to communication that provides a series of data to a user in succession. In such immediacy-demanding communication, it is preferable that data transmission and reception be continuously performed, and therefore, it is preferable that communication not only be continued for the longest possible time but also involve breaks of the shortest possible lengths. For example, immediacy-demanding communication includes communication that provides IPTV (Internet Protocol TeleVision). In the case of IPTV, a series of moving images is transmitted to a user, and it is inconvenient for the user if frequent interruptions of communication result in intermittent presentation of the moving images. Therefore, communication that provides IPTV demands immediacy.

The transmission power management unit 3 acquires transmission power for the respective communication scheme from the transmission power detection units 213 and 223. Then, the transmission power management unit 3 obtains SAR values from the acquired transmission power, and then calculates the sum of the SAR values. The transmission power management unit 3 determines whether the sum of the SAR values is less than or equal to the SAR reference value.

When the sum of the SAR values exceeds the SAR reference value, the transmission power management unit 3 acquires, from the protocol control units 214 and 224, information on applications using communication performed with the respective communication schemes. The transmission power management unit 3 previously stores information on applications that may use immediacy-demanding communication. Then, the transmission power management unit 3 determines whether any immediacy-demanding communication is currently being performed in the protocol control unit 214 or 224.

Then, when there is any immediacy-demanding communication currently being performed, the transmission power management unit 3 determines timing of communication performed with the respective communication schemes so that a longer time slot may be assigned to the communication scheme with which the immediacy-demanding communication is currently being performed, among the communications performed in a time-division manner, than a time assigned to the other communication scheme. For example, suppose that, while IPTV is being provided using the CDMA scheme, communication other than immediacy-demanding communication is being performed with the WiMAX scheme. Then, the transmission power management unit 3 sets a time assigned to the CDMA-scheme communication longer than a time assigned to the WiMAX-scheme communication. Hereinafter, this variation is described as a case where IPTV is provided using the CDMA-scheme communication.

The transmission power management unit 3 notifies the protocol control units 214 and 224 of instructions thereto to stop communication and restart communication so that communication using the respective communication schemes may be performed in accordance with the determined timing. This causes the radio control units 11 and 12, the CDMA system control unit 21 and the WiMAX system control unit 22 to perform the communications in a time-division manner where a longer time is assigned to the communication providing IPTV than to the other communication.

Thereafter, at predetermined SAR detection intervals applicable to a case when the communications are being performed in a time-division manner where a longer time slot is assigned to the immediacy-demanding communication, the transmission power management unit 3 determines whether a predicted value of the sum of SAR values is less than or equal to the SAR reference value. Then, when the predicted value of the sum of SAR values is less than or equal to the SAR reference value, the transmission power management unit 3 cancels the time-division manner applied to the communications.

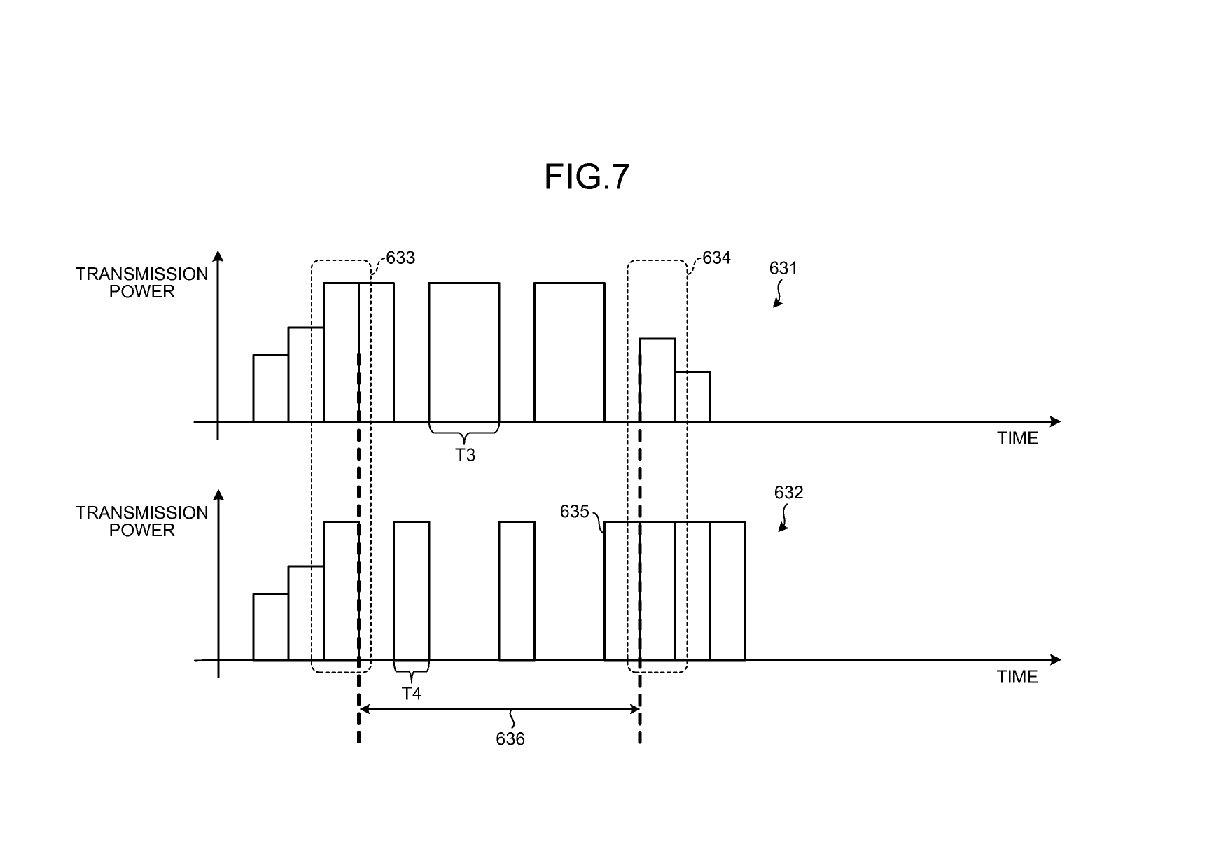

Next, changes in transmission power in a case when communications are being performed in a time-division manner in the mobile phone device according to this embodiment are described with reference to FIG. 7. FIG. 7 is a diagram for explaining changes in transmission power in a case when communications are being performed in a time-division manner in Variation 1. A graph 631 of FIG. 7 represents changes over time in transmission power for the CDMA scheme. On the other hand, a graph 632 of FIG. 7 represents changes over time in transmission power for the WiMAX scheme. In each of the graphs 631 and 632, the vertical axis represents transmission power, and the horizontal axis represents time.

As depicted in the graphs 631 and 632, the mobile phone device according to this embodiment is concurrently performing CDMA-scheme communication and the WiMAX-scheme communication at the start. Then, at a time point 633, the transmission power management unit 3 determines the sum of the SAR values to have exceeded the SAR reference value. Further, the transmission power management unit 3 determines whether there is any communication scheme with which immediacy-demanding communication is being performed. Here, it is assumed that communication that provides IPTV is being performed with the CDMA scheme. In that case, the transmission power management unit 3 starts performing the communications in a time-division manner where communication time periods, assigned to the respective communication schemes so that a longer communication time period may be assigned to the CDMA-scheme than to the WiMAX-scheme communication, are repeated. For example, the transmission power management unit 3 assigns a time period of T3 to the CDMA scheme and assigns to the WiMAX scheme a time period of T4 that satisfies T3>T4. Then, the transmission power management unit 3 repeats the time-division manner where, after the CDMA scheme communication is performed for a time period of T4, the WiMAX-scheme communication for a time period of T3 is performed. As depicted in FIG. 7, while being performed in a time-division manner, the CDMA-scheme communication and the WiMAX-scheme communication are not performed concurrently. Therefore, the sum of an SAR value associated with the CDMA-scheme communication and an SAR value associated with the WiMAX-scheme communication remains less than or equal to the SAR reference value.

Further, while performing the communications in a time-division manner, the transmission power management unit 3 calculates the sum of an SAR value corresponding to a predicted value of transmission power for the communication scheme with which communication is being stopped and an SAR value corresponding to transmission power for the communication scheme with which communication is being performed, namely, a predicted value of the sum of SAR values. Then, when the predicted value of the sum of SAR values is less than or equal to the SAR reference value, the transmission power management unit 3 cancels the time-division manner applied to the communications. Here, it is assumed that the predicted value of the sum of the SAR value has fallen below the SAR reference value by the time when transmission power 635 has emerged for the WiMAX scheme. In this case, the transmission power management unit 3 instructs the protocol control units 214 and 224 to cancel, at a time point 634, the time-division manner applied to the communications and then concurrently perform the CDMA-scheme communication and the WiMAX scheme-communication. By the time point 634, transmission power for the CDMA-scheme communication has already gone down, and hence, the sum of the SAR values has been less than or equal to the SAR reference value. In this case, a time period 636 turns out to be a time period for which the communications have been performed in a time-division manner.

The communication control thus performed by the transmission power management unit 3 makes it possible to perform communications in a time-division manner where a longer time slot is assigned to an immediacy-demanding communication, and to avoid superimposition of transmission power for communications using different communication schemes. Additionally, the communication control sets a time slot assigned to an immediacy-demanding communication longer, and sets a time slot assigned to the other communication shorter, thereby making it possible to involve less frequent breaks in an immediacy-demanding communication. This makes it possible to secure immediacy demanded by a user.

Variation 2

Next, Variation 2 of the second embodiment is described. This variation is characterized in that the lengths of time slots assigned to communications performed in a time-division manner are changed based on radio wave environments of the communications. An electric wave environment is considered favorable when data transmission is enabled with weak transmission power.

The transmission power management unit 3 acquires transmission power for the respective communication schemes from the transmission power detecting units 213 and 223. Then, the transmission power management unit 3 obtains SAR values from the acquired transmission power, and thereafter, calculates the sum of the SAR values. The transmission power management unit 3 determines whether the sum of the SAR values is less than or equal to the SAR reference value.

When the sum of the SAR values exceeds the SAR reference value, the transmission power management unit 3 uses the acquired transmission power to identify, among communications performed with the respective communication schemes, a communication that is performed with the smallest transmission power.

Then, the transmission power management unit 3 determines timing for the respective communication schemes to perform communications, so that a longer time slot may be assigned to the communication scheme performing a communication with the smallest transmission power, among the communications performed in a time-division manner, than to the other communication scheme. For example, when the CDMA-scheme communication uses the smallest transmission power, the transmission power management unit 3 sets a time slot assigned to the CDMA-scheme communication longer than a time slot assigned to the WiMAX-scheme communication. Hereinafter, description is given of a case when the CDMA-scheme communication uses the smallest transmission power.

The transmission power management unit 3 notifies the protocol control units 214 and 224 of instructions thereto to stop and restart communications so that the communications with the respective communication schemes may be performed with the determined timing. This causes the radio control units 11 and 12, the CDMA system control unit 21 and the WiMAX system control unit 22 to perform communications in a time-division manner where a longer time slot is assigned to the communication using the smallest transmission power.

Thereafter, at predetermined SAR detection intervals that are applicable to a case when communications are being performed in a time-division manner where a longer time slot is assigned to a communication using the smallest transmission power, the transmission power management unit 3 determines whether the predicted value of the sum of SAR values is less than or equal to the SAR reference value. Then, when the predicted value of the sum of SAR values is less than or equal to the SAR reference value, the transmission power management unit 3 cancels the time-division manner applied to the communications.

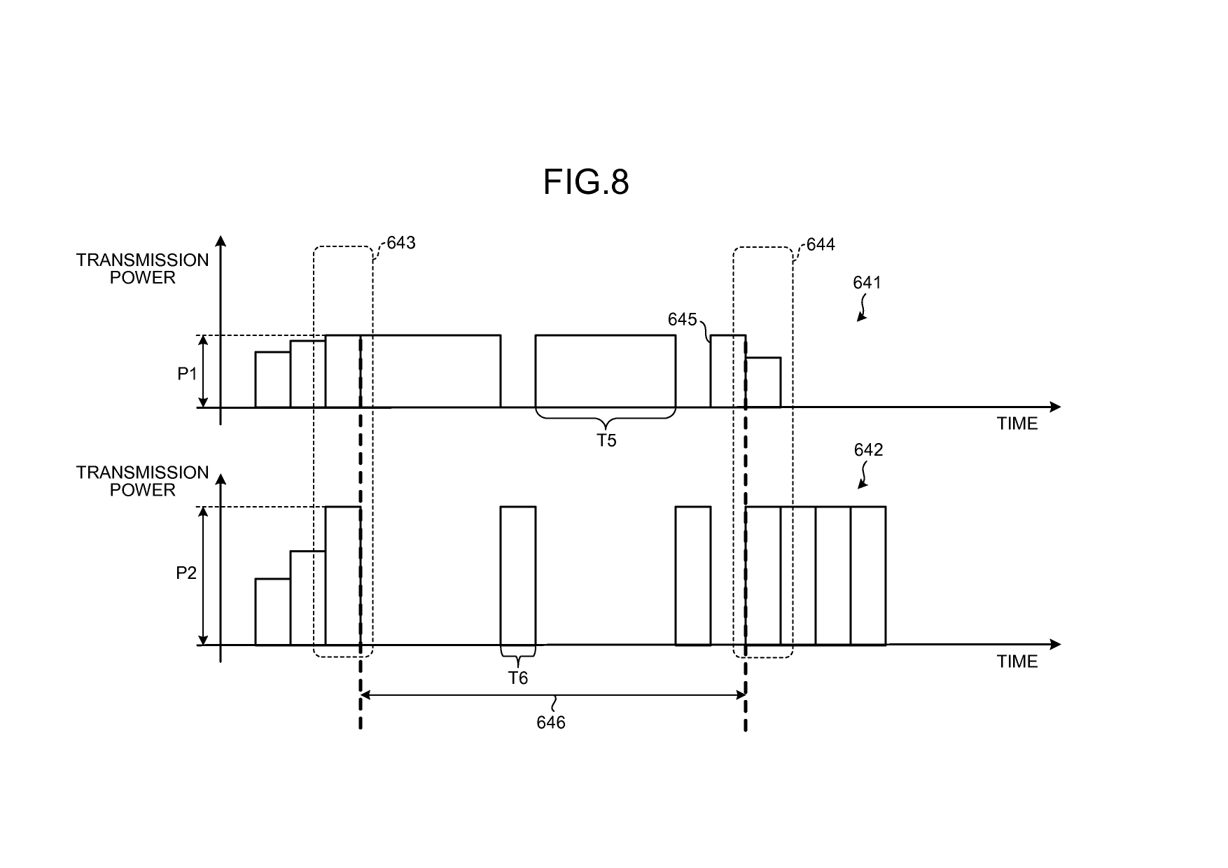

Next, changes in transmission power in a case when communications are performed in a time-division manner in the mobile phone device according to this embodiment are described with reference to FIG. 8. FIG. 8 is a diagram for illustrating changes in transmission power in a case when communications are performed in a time-division manner according to Variation 2. A graph 641 of FIG. 8 represents changes over time in transmission power for the CDMA scheme. On the other hand, a graph 642 of FIG. 8 represents changes over time in transmission power for the WiMAX scheme. In both of the graph 641 and the graph 642, the vertical axis represents transmission power, and the horizontal axis represents time.

As depicted in the graphs 641 and 642, the mobile phone device according to this embodiment are concurrently performing a CDMA-scheme communication and a WiMAX-scheme communication at the start. Then, at a time point 643, the transmission power management unit 3 determines the sum of SAR values to have exceeded the SAR reference value. Further, the transmission power management unit 3 identifies, among the communication schemes, the communication scheme that is performing a communication with the smallest transmission power. Here, it is assumed that the CDMA-scheme communication is performed with the smallest transmission power. Specifically, the CDMA-scheme communication is performed with a transmission power P1. The WiMAX-scheme communication is performed with a transmission power P2. In that case, the transmission power management unit 3 starts performing communication in a time-division manner where communication time periods are alternately repeated which have been assigned to the respective communication schemes so that the CDMA-scheme communication may be performed longer than the WiMAX-scheme communication. For example, the transmission power management unit 3 assigns a time period of T5 to the CDMA scheme, and assigns to the WiMAX scheme a time period of T6 that satisfies T5>T6. Then, the transmission power management unit 3 repeats communications in a time-division manner where the WiMAX-scheme communication is performed for a time period of T6 after the CDMA-scheme communication is performed for a time period of T5. While being performed in a time-division manner, the-CDMA scheme communication and the WiMAX-scheme communication are not concurrently performed, as depicted in FIG. 8. Therefore, the sum of an SAR value associated with the CDMA-scheme communication and an SAR value associated with the WiMAX-scheme communication is held at or below the SAR reference value.

Further, while performing the communications in a time-division manner, the transmission power management unit 3 calculates the sum of a SAR value corresponding to a predicted value of transmission power for the communication scheme for which communication is being stopped and an SAR value corresponding to transmission power for the communication scheme for which communicating is being performed, namely, a predicted value of the sum of SAR values. Then, the transmission power management unit 3 cancels the application of the time-division manner to the communications when the predicted value of the sum of SAR values has exceeded the SAR reference value. Here, it is assumed that the predicted value of the sum of SAR values is less than the SAR reference value when transmission power 645 has emerged for the CDMA scheme. In this case, the transmission power management unit 3 instructs the protocol control units 214 and 224 to cancel, at a time point 644, the time-division manner applied to the communications and then concurrently perform the CDMA-scheme and WiMAX-scheme communications. By the time point 644, the transmission power for the CDMA-scheme communication has already gone down, and hence, the sum of the SAR values is less than or equal to the SAR reference value. In this case, a time period 646 turns out to be a time period for which the communications have been performed in a time-division manner.

The communication control thus performed by the transmission power management unit 3 makes it possible to perform communications in a time-division manner where a longer time period is assigned to a communication that uses less transmission power than the other communications. The communication control also makes it possible to avoid superimposition of transmission power for communications performed with different communication schemes. Additionally, in the communication control, while a longer time slot is assigned to a communication being performed in a favorable radio wave environment, that is, one being performed with the small transmission power, a shorter time is assigned to the other communications. This enables early completion of a communication, the radio wave environment of which is favorable, that has a low likelihood of inviting retransmission thereof or the like and that is therefore expected to be promptly completed.

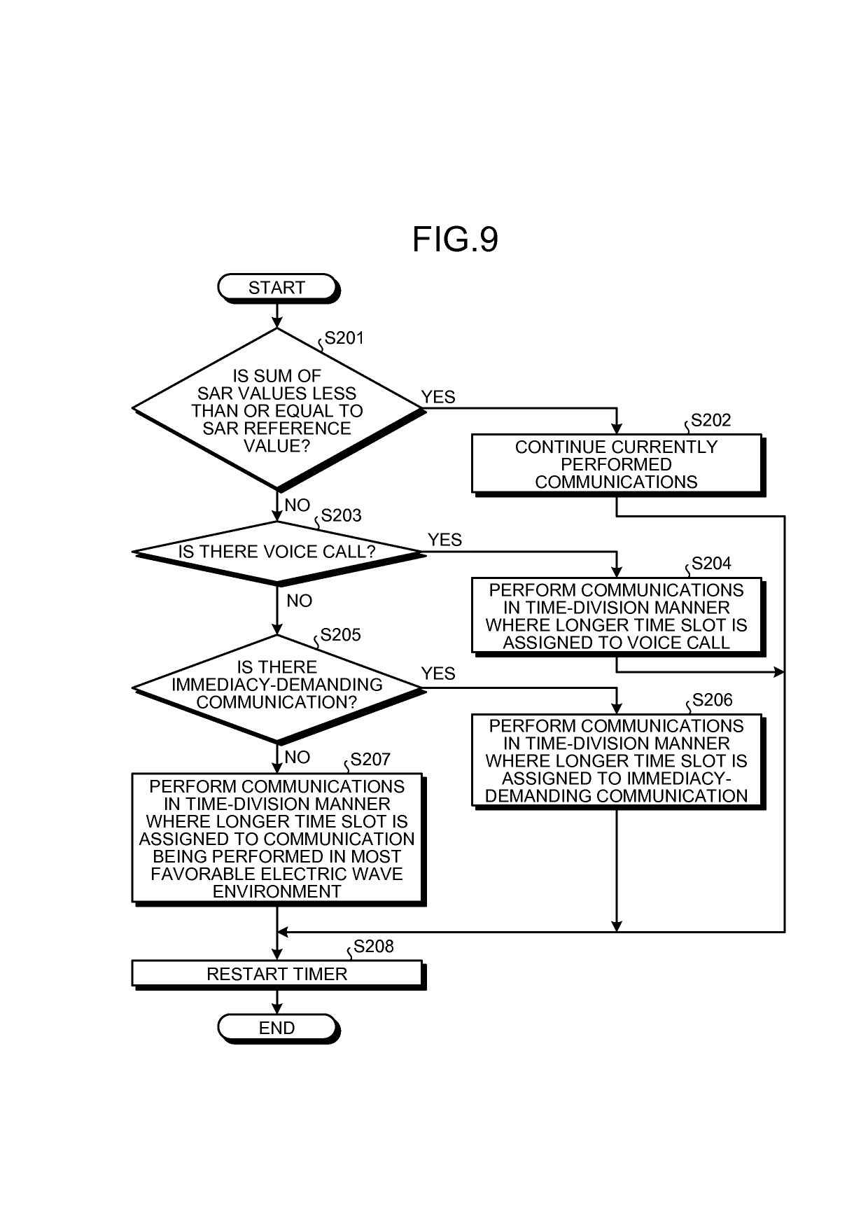

Further, the above described manners of controlling time slots to be assigned to communications performed in a time-division manner, which use determination based on whether each communications is a voice call, whether each communication is an immediacy-demanding communication, and whether each communication is in a favorable electric wave environment, respectively, may be used in combination. Accordingly, control of time slots to be assigned to communications performed in a time-division manner, in a case where those manners are used in combination, is described with reference to FIG. 9. FIG. 9 is a flowchart depicting an example of processing in a case where those manners of controlling time periods to be assigned to communications performed in a time-division manner are used in combination. Although three determination criteria are used in combination here, any two thereof may be used in combination, or another criterion with which to determine time slots to be assigned may be used in combination.

The transmission power management unit 3 obtains SAR values from transmission power for the respective communication schemes, and thereafter, determines whether the sum of the SAR values is less than or equal to the SAR reference value (step S201). When the sum of the SAR values is less than or equal to the SAR reference value (step S201: Yes), the transmission power management unit 3 continues concurrent communication using two or more communication schemes that is currently performed (step S202).

On the other hand, when the sums of the SAR values exceeds the SAR reference value (step S201: No), the transmission power management unit 3 determines whether there is a voice call out of the currently performed communications (step S203). When there is a voice call (step S203: Yes), the transmission power management unit 3 starts performing the communications in a time-division manner where a longer time slot is assigned to the communication scheme with which a voice call is being performed (step S204).

On the other hand, when there is no voice call (step S203: No), the transmission power management unit 3 determines whether there is an immediacy-demanding communication out of the currently performed communication (step S205). When there is an immediacy-demanding communication (step S205: Yes), the transmission power management unit 3 starts performing the communications in a time-division manner where a longer time slot is assigned to the communication scheme with which the immediacy-demanding communication is being performed (step S206).

On the other hand, when there is no immediacy-demanding communication (step S205: No), the transmission power management unit 3 identifies a communication that is using the smallest transmission power among the currently performed communications. Then, the transmission power management unit 3 starts performing the communications in a time-division manner where a longer time slot is assigned to the communication scheme with which a communication with the smallest transmission power is being performed, that is, a communication in the most favorable electric wave environment (step S207).

Thereafter, the transmission power management unit 3 restarts its own timer (step S208), and counts SAR detection intervals that correspond to the respective communications performed in any one of the respective time-division manners by using the timer, and repeats determination as to whether a predicted value of the sum of SAR values is less than or equal to the SAR reference value at the SAR detection intervals.

Thus, using two or more criteria to determine time slots to be assigned to communications performed in a time-division manner makes it possible to execute the communications in a time-division manner that is more suitable for the communication schemes that are performing communications.

Further, the above described embodiments are described through cases where two communication schemes, the CDMA scheme and the WiMAX scheme, are used. However, the communication schemes used may include another communication scheme such as LTE. Additionally, the embodiments may be applied to a case where communications based on three or more communication schemes are concurrently preformed.

Further, although the SAR reference value is described as being a fixed value, the SAR reference value may be changeable. In that case, the SAR reference value is changed, for example, when the SAR reference value is inputted by an operator through the user interface 5. In this case, the operator may input a desired numerical value, or may select one from predetermined values. Alternatively, the SAR reference value may be set in such a manner that a file, to be used for setting the SAR reference value, created by the manufacturer of the mobile phone device is memorized in the transmission power management unit 3 or the like, the transmission power management unit 3 read the file. In this case, it is preferable that preparation be made for, even when the mobile phone device is in operation, enabling easy setting of the reference value, for example, through cabled communication, radio communication, or a storage device (such as a memory card).

Hardware Configuration

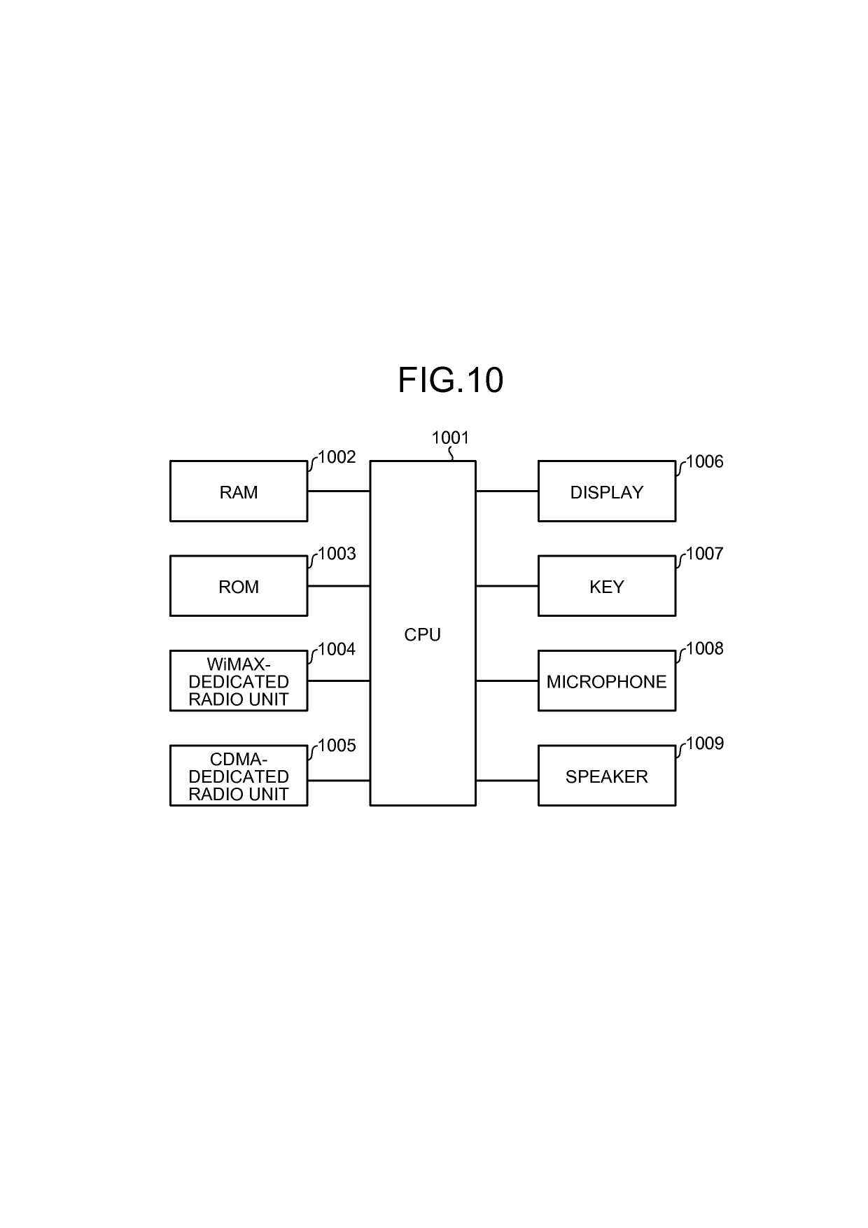

Then, the hardware configuration of the mobile phone described in each of the above embodiments is described with reference to FIG. 10. FIG. 10 is a diagram of the hardware configuration of the mobile phone device.

The mobile phone according to each of the embodiments includes a CPU (Central Processing Unit) 1001, a RAM (Random Access Memory) 1002, a ROM (Read Only Memory) 1003, a WiMAX-dedicated radio unit 1004 and a CDMA-dedicated radio unit 1005. Further, the mobile phone according to each of the embodiment includes a display 1006, keys 1007, a microphone 1008 and a speaker 1009.

The RAM 1002, the ROM 1003, the WiMAX-dedicated radio unit 1004, the CDMA-dedicated radio unit 1005, the display 1006, the keys 1007, the microphone 1008 and the speaker 1009 are connected to the CPU 1001 through buses, respectively.

The WiMAX-dedicated radio unit 1004 performs WiMAX-scheme communication through an antenna. The WiMAX-dedicated radio unit 1004 implements, for example, the functions of the radio control unit 12 that are depicted in FIG. 1. The CDMA-dedicated radio unit 1005 performs CDMA-scheme communication through an antenna. The CDMA-dedicated radio unit 1005 implements, for example, the functions of the radio control unit 11 that are depicted in FIG. 1.

The display 1006 is a liquid crystal screen or the like. Additionally, the keys 1007 are a keypad or other operation buttons. Then, the display 1006, the keys 1007, the microphone 1008 and the speaker 1009 implement the functions of the user interface 5 depicted in FIG. 1.

For example, the CPU 1001, the RAM 1002 and the ROM 1003 implement the functions of the CDMA system control unit 21, the WiMAX system control unit 22 and the application execution unit 4, which are depicted in FIG. 1.

The RAM 1002 stores, for example, the SAR reference value, information on correlations between SAR values and transmission power, and various applications.

The ROM 1003 stores, for example, various programs that implement the functions of the CDMA system control unit 21, the WiMAX system control unit 22 and the application execution unit 4, which are depicted in FIG. 1. Then, the CPU 1001 reads out these various programs from the ROM 1003 to generate and execute a process that implements the above described functions.

One aspect of any one of the radio communication terminal device and the radio communication terminal device control method that are disclosed in this application has the effect of enabling achievement of a reduced SAR value in concurrently performing communications using two or more different communication schemes.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication terminal device comprising:
a radio communication unit that performs a plurality of communications by using a plurality of different communication schemes;
a transmission power detection unit that detects transmission power used for communications that the radio communication unit performs by using the respective communication schemes; and
a control unit that, based on the transmission power detected by the transmission power detection unit, obtains the sum of specific absorption rates associated with the respective communication schemes, and, when the thus obtained sum of the specific absorption rates exceeds a predetermined reference value, controls the radio communication unit to perform the communications in a time-division manner in order for the respective communications using the plurality of communication schemes to be non-concurrently performed.

2. The radio communication terminal device according to claim 1, wherein, when the communications using the plurality of different communication schemes include a communication that is being used for making a voice call, the control unit performs the communications in a time-division manner where a longer time slot is assigned to the communication through which a voice call is made than to the other communications.

3. The radio communication terminal device according to claim 2, wherein the control unit detects a time period when voice has not been transmitted in the communication being used for making a voice call, and performs the other communication during the detected time period.

4. The radio communication terminal device according to claim 1, wherein, when the communications using the plurality of different communication schemes include a communication that is providing a series of data in succession, the control unit performs the communications in a time-division manner where a longer time is assigned to the communication providing a series of data in succession than to the other communications.

5. The radio communication terminal device according to claim 1, wherein the control unit performs the communication in a time-division manner where a longer time slot is assigned to the communication that is being performed in the most favorable radio wave environment among the communications using the plurality of different communication schemes than to the other communication.

6. The radio communication terminal device according to claim 1, wherein, while controlling the radio communication unit in order for the communications to be performed in a time-division manner, the control unit obtains predicted transmission power used for halted communication, then obtains, based on the predicted transmission power and transmission power, used in the currently performed communication, that has been detected by the transmission power detection unit, the sum of specific absorption rates for a hypothetical case when the respective communications are concurrently being performed, and controls, when the thus obtained sum of specific absorption rates is less than or equal to the predetermined reference value, the radio communication unit in a manner that terminates the time sharing and starts concurrent performance of the respective communications.

7. A radio communication terminal device control method comprising:
concurrently performing a plurality of communications using a plurality of different communication schemes;
detecting transmission power used for the respective communications;
based on the transmission power detected by the transmission power detection unit, obtaining the sum of specific absorption rates associated with the respective communication schemes; and
when the thus obtained sum of the specific absorption rates exceeds a predetermined reference value, controlling the radio communication unit in a manner that causes the communications to be performed in a time-division manner in order for the respective communications using the plurality of communication schemes to be non-concurrently performed.
